(19) United States
(12) Patent Application Publication
(10) Pub. No.: US 2014/0285840 A1
(43) Pub. Date: Sep. 25, 2014

(54) COMMUNICATION SYSTEM, INFORMATION PROCESSING APPARATUS, IMAGE PROCESSING APPARATUS, AND NON-TRANSITORY COMPUTER READABLE MEDIUM

(71) Applicant: FUJI XEROX CO., LTD., Tokyo (JP)

(72) Inventor: Yosuke SHINNAKA, Kanagawa (JP)

(73) Assignee: FUJI XEROX CO., LTD., Tokyo (JP)

(21) Appl. No.: 14/080,452

(22) Filed: Nov. 14, 2013

(30) Foreign Application Priority Data
Mar. 21, 2013 (JP) 2013-057921

(51) Int. Cl. H04N 1/32; H04N 1/00

(52) U.S. Cl. CPC H04N 1/32037; H04N 1/00278
USPC 358/1.15

(57) ABSTRACT

A communication system includes an information processing apparatus and an image processing apparatus. The information processing apparatus includes an image data receiving unit, a memory, a processing identification data receiving unit, a processing-related data transmitting unit, and a processing unit. The image processing apparatus includes an image data obtaining unit, an image data transmitting unit, a processing identification data transmitting unit, a processing-related data receiving unit, and an image formation instruction unit.

### CROSS-REFERENCE TO RELATED APPLICATIONS

This application is based on and claims priority under 35 USC 119 from Japanese Patent Application No. 2013-057921 filed Mar. 21, 2013.

### BACKGROUND

(i) Technical Field

The present invention relates to a communication system, an information processing apparatus, an image processing apparatus, and a non-transitory computer readable medium.

(ii) Related Art

Services called cloud services or cloud computing are available. In such a service, for example, a server apparatus in a network performs various information processing operations, such as storage of data and conversion of a data format, on behalf of a client apparatus. Also, there is suggested a technology of classifying or managing data by performing processing, such as character recognition processing called optical character recognition (OCR), on image data representing a document.

### SUMMARY

According to an aspect of the invention, there is provided a communication system including an information processing apparatus and an image processing apparatus. The information processing apparatus includes an image data receiving unit, a memory, a processing identification data receiving unit, a processing-related data transmitting unit, and a processing unit. The image data receiving unit receives image data from the image processing apparatus. The memory stores, for each of plural information processing operations that are performed by using the image data received by the image data receiving unit, processing identification data identifying the information processing operation and processing-related data representing information on the information processing operation in association with each other. The processing identification data receiving unit receives, from the image processing apparatus, processing identification data identifying an information processing operation selected by a user. A processing-related data transmitting unit transmits, to the image processing apparatus, the processing-related data stored in the memory in association with the processing identification data received by the processing identification data receiving unit. The processing unit performs, by using the image data received by the image data receiving unit, processing related to the information processing operation identified by the processing identification data received by the processing identification data receiving unit. The image processing apparatus includes an image data obtaining unit, an image data transmitting unit, a processing identification data transmitting unit, a processing-related data receiving unit, and an image formation instruction unit. The image data obtaining unit obtains image data. The image data transmitting unit transmits the image data obtained by the image data obtaining unit to the information processing apparatus. The processing identification data transmitting unit transmits, to the information processing apparatus, processing identification data identifying an information processing operation selected by a user from among plural information processing operations that are performed by using the image data obtained by the image data obtaining unit. The processing-related data receiving unit receives processing-related data representing information on the information processing operation, the processing-related data being transmitted from the information processing apparatus as a response to the processing identification data transmitted by the processing identification data transmitting unit. The image formation instruction unit instructs an image forming device that forms an image on a recording medium to form an image representing information represented by the processing-related data received by the processing-related data receiving unit.

### BRIEF DESCRIPTION OF THE DRAWINGS

An exemplary embodiment of the present invention will be described in detail based on the following figures, wherein:

FIG. 1 is a block diagram illustrating the overall configuration of a communication system;

FIG. 2 is a diagram illustrating the hardware configuration of a storage service providing apparatus;

FIG. 3 is a diagram illustrating the hardware configuration of an image processing apparatus;

FIG. 4 is a diagram illustrating the hardware configuration of a relay apparatus;

FIG. 5 is a diagram illustrating the hardware configuration of a flow management apparatus;

FIG. 6 is a diagram illustrating the functional configuration of the communication system;

FIG. 7 is a sequence chart illustrating a process of storing image data;

FIG. 8A is a diagram illustrating an example of a screen displayed on a display of the image processing apparatus;

FIG. 8B is a diagram illustrating an example of a screen displayed on the display of the image processing apparatus;

FIG. 9A is a diagram illustrating an example of an image formed on a sheet by the image processing apparatus;

FIG. 9B is a diagram illustrating an example of an image formed on a sheet by the image processing apparatus;

FIG. 9C is a diagram illustrating an example of an image formed on a sheet by the image processing apparatus;

FIG. 10 is a block diagram illustrating the overall configuration of the communication system;

FIG. 11A is a diagram illustrating an example of an image formed on a sheet by the image processing apparatus; and

FIG. 11B is a diagram illustrating an example of an image formed on a sheet by the image processing apparatus.

### DETAILED DESCRIPTION

### Configuration

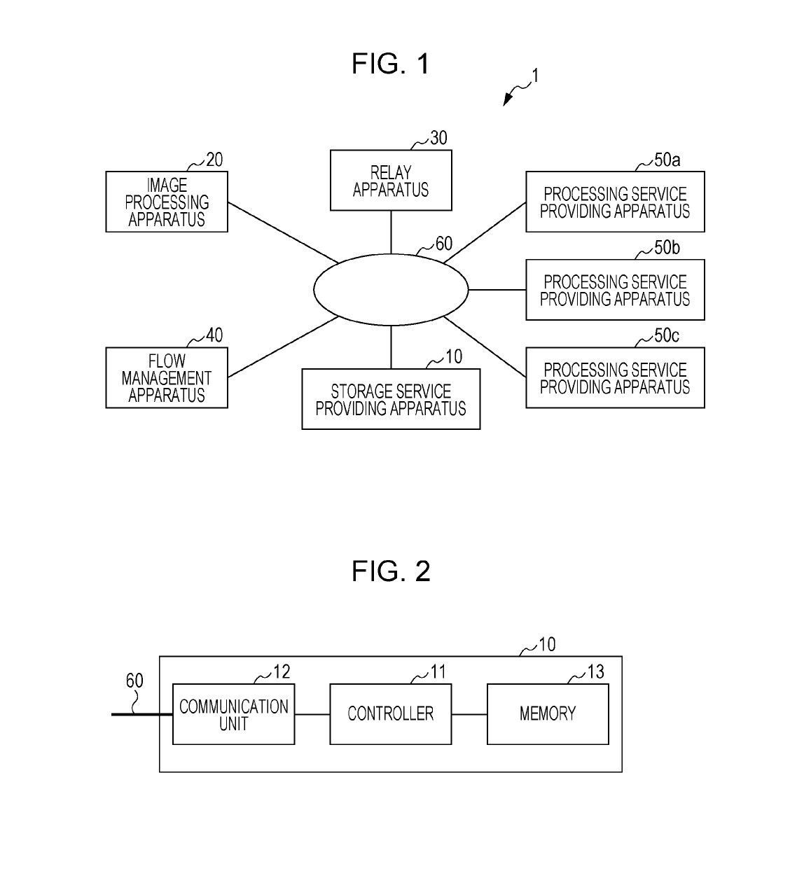

FIG. 1 is a block diagram illustrating the overall configuration of a communication system 1 according to an exemplary embodiment of the present invention. The communication system 1 includes a storage service providing apparatus 10, an image processing apparatus 20, a relay apparatus 30, a flow management apparatus 40, and processing service providing apparatuses 50a, 50b, and 50c. The storage service providing apparatus 10 and the processing service providing apparatuses 50a, 50b, and 50c are server apparatuses that provide a so-called cloud service. Here, a cloud service is a service in which, for example, a server apparatus in a network performs various information processing operations, such as storing and providing of data. The storage service providing apparatus 10 is an apparatus that mainly stores and provides data. The processing service providing apparatuses 50a, 50b, and 50c are apparatuses that perform various information processing operations, such as character recognition processing called optical character recognition (OCR), data format conversion processing, and translation processing. Hereinafter, the services provided by the processing service providing apparatuses 50a, 50b, and 50c are referred to as “processing services” for the convenience of description.

The image processing apparatus 20 is an apparatus that receives services provided by the storage service providing apparatus 10 and the processing service providing apparatuses 50a, 50b, and 50c. In this exemplary embodiment, the image processing apparatus 20 has a print function and a scanner function. A network 60 is a communication network that connects the image processing apparatus 20, the relay apparatus 30, the flow management apparatus 40, the storage service providing apparatus 10, and the processing service providing apparatuses 50a, 50b, and 50c to one another, and is the Internet, for example.

The relay apparatus 30 relays data that is transmitted and received between the storage service providing apparatus 10 and the image processing apparatus 20, when a storage service is provided from the storage service providing apparatus 10 to the image processing apparatus 20. More specifically, for example, upon receiving data to be stored from the image processing apparatus 20, the relay apparatus 30 transfers the data to the storage service providing apparatus 10. Also, upon receiving data to be printed from the storage service providing apparatus 10, the relay apparatus 30 transfers the data to the image processing apparatus 20.

The flow management apparatus 40 is an apparatus that manages a processing service performed on data relayed by the relay apparatus 30. In this exemplary embodiment, a user utilizes one or plural processing services for data to be stored, before storing the data in the storage service providing apparatus 10. Plural combinations of processing services that are provided by the processing service providing apparatuses 50a, 50b, and 50c are registered in advance in the flow management apparatus 40. The flow management apparatus 40 requests the processing service providing apparatus 50a, 50b, or 50c to provide a processing service selected by the user in accordance with data received from the relay apparatus 30. Hereinafter, an information processing operation that is performed on data to be stored is referred to as a “flow”, and a combination of plural flows is referred to as a “flow combination” for the convenience of description. The processing service providing apparatuses 50a, 50b, and 50c have the same hardware configuration and operate in the same manner, and are hereinafter referred to as processing service providing apparatuses 50 except in a case where they are distinguished from one another.

FIG. 2 is a diagram illustrating the hardware configuration of the storage service providing apparatus 10. In FIG. 2, a controller 11 includes an arithmetic unit such as a central processing unit (CPU), and main memories such as a read only memory (ROM) and a random access memory (RAM). The arithmetic unit executes a program stored in the ROM or a memory 13 by using the RAM as a working area, thereby controlling the operations of the individual units of the storage service providing apparatus 10. A communication unit 12 communicates with the relay apparatus 30 via the network 60. The memory 13 is a storage device such as a hard disk, and stores data and programs used by the controller 11. The memory 13 stores data that is transmitted from the image processing apparatus 20 via the relay apparatus 30.

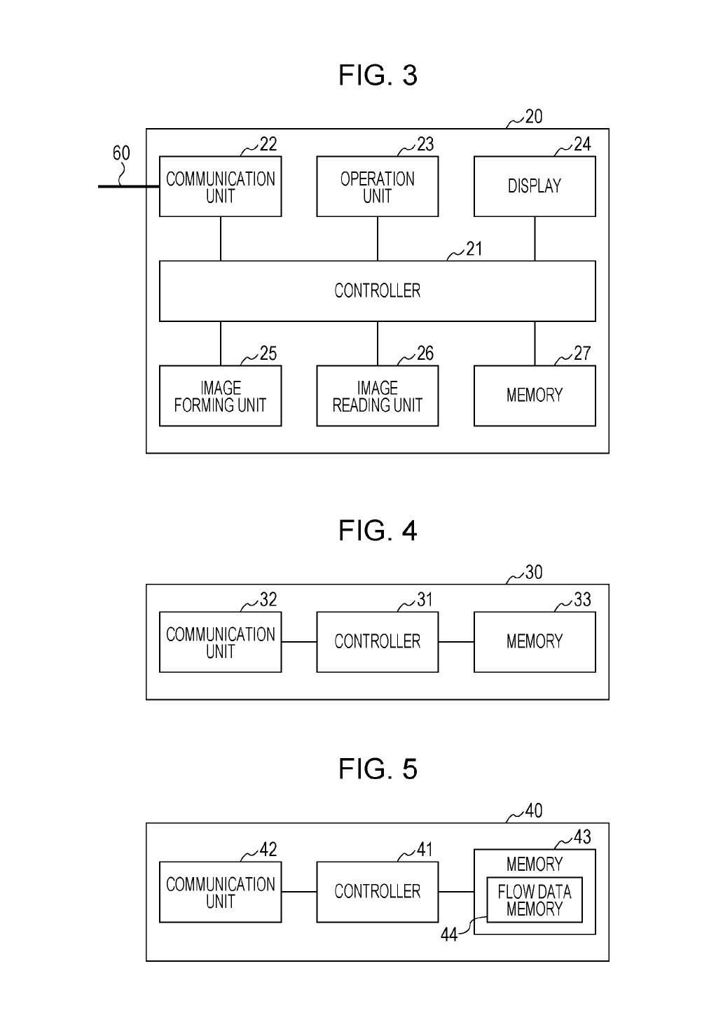

FIG. 3 is a diagram illustrating the hardware configuration of the image processing apparatus 20. In FIG. 3, a controller 21 includes an arithmetic unit such as a CPU, and main memories such as a ROM and a RAM. The ROM stores a program executed by the arithmetic unit. The arithmetic unit executes a program stored in the ROM or a memory 27 by using the RAM as a working area, thereby controlling the operations of the individual units of the image processing apparatus 20. A communication unit 22 communicates with the relay apparatus 30 via the network 60. An operation unit 23 includes operation elements, such as various keys and a touch sensor, and supplies an operation signal to the controller 21 in response to a user operation. The controller 21 performs processing in response to the operation signal. A display 24 includes a liquid crystal panel and a liquid crystal drive circuit, and displays an image under control performed by the controller 21. An image forming unit 25 forms an image on a recording medium, such as a sheet, by using an electrophotographic system. An image reading unit 26 optically reads an image of a document. The memory 27 is a storage device such as a hard disk, and stores data and programs used by the controller 21.

FIG. 4 is a diagram illustrating the hardware configuration of the relay apparatus 30. In FIG. 4, a controller 31 includes an arithmetic unit such as a CPU, and main memories such as a ROM and a RAM. The arithmetic unit executes a program stored in the ROM or a memory 33 by using the RAM as a working area, thereby controlling the operations of the individual units of the relay apparatus 30. A communication unit 32 communicates with the image processing apparatus 20 and the storage service providing apparatus 10 via the network 60. The memory 33 is a storage device such as a hard disk, and stores data and programs used by the controller 31.

FIG. 5 is a diagram illustrating the hardware configuration of the flow management apparatus 40. In FIG. 5, a controller 41 includes an arithmetic unit such as a CPU, and main memories such as a ROM and a RAM. The arithmetic unit executes a program stored in the ROM or a memory 43 by using the RAM as a working area, thereby controlling the operations of the individual units of the flow management apparatus 40. A communication unit 42 communicates with the relay apparatus 30 and the processing service providing apparatus 50 via the network 60. The memory 43 is a storage device such as a hard disk, and stores data and programs used by the controller 41. The memory 43 includes a flow data memory 44. The flow data memory 44 stores, for each of plural information processing operations (flows) that are performed by using image data, processing identification data identifying the flow, and flow data related to the flow (processing-related data) in association with each other. In this exemplary embodiment, the flow data includes overview data representing the overview (explanation) of the corresponding flow, and data representing an image of a form that prompts a user to select a processing condition (attribute) of the corresponding flow (for example, an image that allows a user to select image resolution (high/middle/low) and color (monochrome/full-color). Hereinafter, data representing an image of a form is referred to as “form data”.

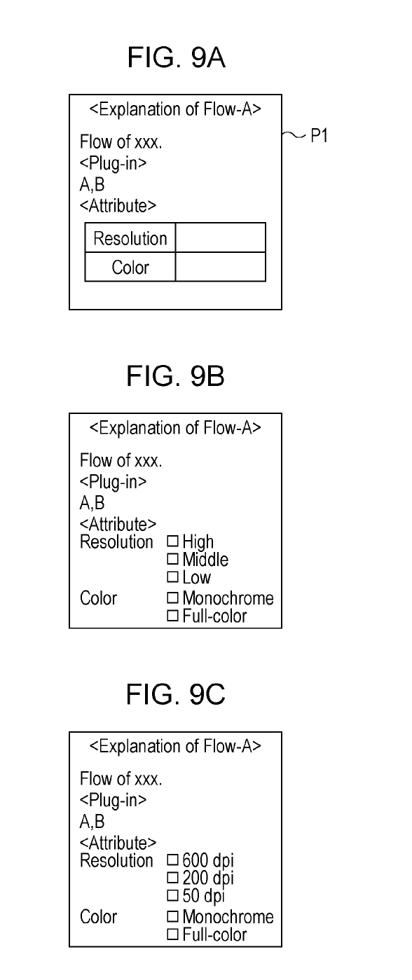

In this exemplary embodiment, the user of the image processing apparatus 20 is capable of designating an attribute by filling out a sheet on which an image that prompts the user to select a processing condition (attribute) of a flow is formed (hereinafter referred to as a “form sheet”). FIG. 9A is a diagram illustrating an example of a form sheet. As illustrated in FIG. 9A, an image of a form that is used for selecting the resolution and color of an image is formed on the form sheet.

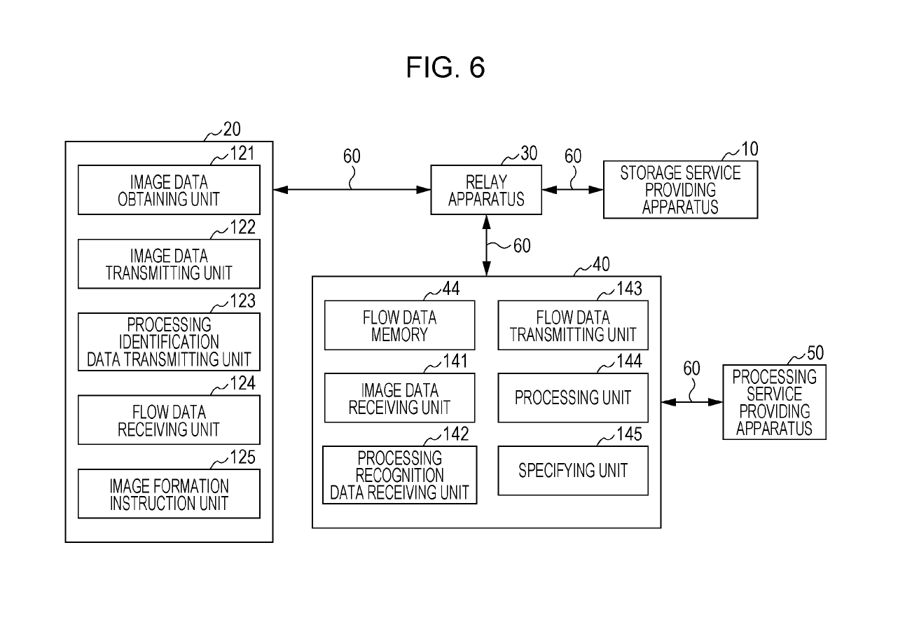

FIG. 6 is a diagram illustrating the functional configuration of the flow management apparatus 40 and the image processing apparatus 20. The flow management apparatus 40 implements, with the controller 41 or with the controller 41 and the communication unit 42, an image data receiving unit 141, a processing identification data receiving unit 142, a flow data transmitting unit 143, a processing unit 144, and a specifying unit 145. The image data receiving unit 141 receives image data from the image processing apparatus 20. The image data includes filled-out form data representing an image of a form that has been filled out by a user.

The processing identification data receiving unit 142 receives processing identification data identifying a flow selected by the user from the image processing apparatus 20. The flow data transmitting unit 143 transmits, to the image processing apparatus 20, flow data stored in the flow data memory 44 in association with the processing identification data received by the processing identification data receiving unit 142.

The specifying unit 145 specifies the condition of the flow written by the user and included in the form represented by the filled-out form data received by the image data receiving unit 141. The processing unit 144 performs processing related to the flow by using the image data received by the image data receiving unit 141 so that the flow identified by the processing identification data received by the processing identification data receiving unit 142 is performed in the condition specified by the specifying unit 145. In this exemplary embodiment, in a case where the flow identified by the processing identification data is to be provided by the processing service providing apparatus 50, the processing unit 144 requests the processing service providing apparatus 50 to perform the flow so that the flow is performed in the condition specified by the specifying unit 145. On the other hand, in a case where the flow identified by the processing identification data is to be performed by the own apparatus (that is, the flow management apparatus 40), the processing unit 144 performs the flow in the condition specified by the specifying unit 145.

The image processing apparatus 20 implements, with the controller 21 or with the controller 21 and the communication unit 22, an image data obtaining unit 121, an image data transmitting unit 122, a processing identification data transmitting unit 123, a flow data receiving unit 124, and an image formation instruction unit 125. The image data obtaining unit 121 obtains image data. The image data that is obtained includes filled-out form data representing an image of a form that has been filled out by a user. The image of the form is formed by the image forming unit 25, and is recorded on a recording medium.

The image data transmitting unit 122 transmits the image data obtained by the image data obtaining unit 121 to the relay apparatus 30. The processing identification data transmitting unit 123 transmits, to the relay apparatus 30, processing identification data identifying a flow selected by a user from among plural flows performed by using the image data obtained by the image data obtaining unit 121. The flow data receiving unit 124 receives flow data that is transmitted from the relay apparatus 30 as a response to the processing identification data transmitted by the processing identification data transmitting unit 123. The image formation instruction unit 125 instructs the image forming unit 25 to form an image of a form represented by the flow data received by the flow data receiving unit 124.

### Operations

Next, operations according to this exemplary embodiment will be described. In the following example of operations, a user U performs an operation for causing the image processing apparatus 20 to generate image data by scanning plural sheets (recording media), and store the image data in the storage service providing apparatus 10. At this time, the user U designates an information processing operation (flow) to be performed on the image data, such as character recognition processing or translation processing, by using the operation unit 23 of the image processing apparatus 20. The relay apparatus 30 relays the communication between the image processing apparatus 20 and the storage service providing apparatus 10, and requests the flow management apparatus 40 to perform a flow on the image data that is to be stored. In the following example of operations, character recognition processing, data format conversion processing, and translation processing are examples of flows to be performed. Among these flows, character recognition processing is performed by the flow management apparatus 40. On the other hand, data format conversion processing and translation processing are requested, by the flow management apparatus 40, to be performed by the processing service providing apparatuses 50.

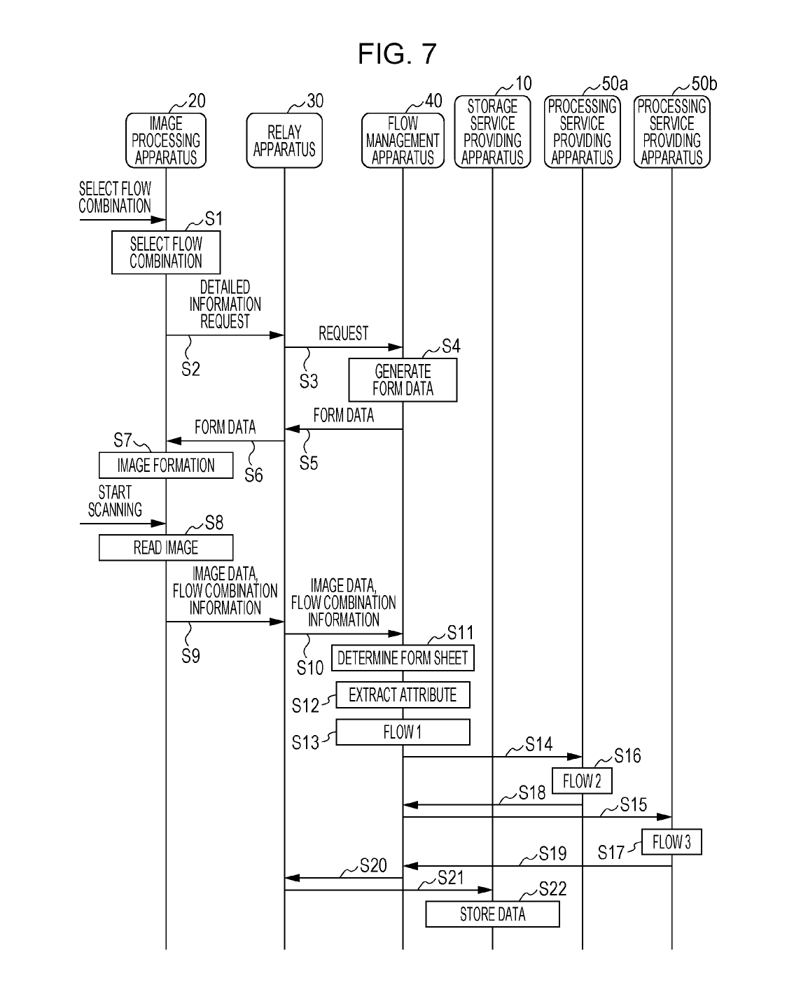

Hereinafter, a description will be given of a process of generating image data by scanning sheets, performing various processing operations on the generated image data, and storing the image data in the storage service providing apparatus 10, with reference to the sequence chart illustrated in FIG. 7. The user U performs an operation for generating image data by scanning sheets, and storing the image data in the storage service providing apparatus 10 by using the operation unit 23 of the image processing apparatus 20. This operation includes a process of inputting authentication information for accessing the storage service providing apparatus 10. The process of inputting authentication information is similar to a process that is performed in a system according to the related art, and thus the detailed description thereof is omitted here. As a method for transmitting and receiving authentication information, for example, authentication using a card may be performed for the image processing apparatus 20, a digital certificate recorded on the card may be read by the image processing apparatus 20, the read digital certificate may be attached to the data that is transmitted and received by the relay apparatus 30 and the flow management apparatus 40, and thereby a user may be specified. Alternatively, for example, a digital certificate obtained by the image processing apparatus 20 may be transformed to a QR code (registered trademark), the QR code may be embedded in a form sheet, and the QR code may be analyzed by the flow management apparatus 40 to perform authentication.

The user U selects a cloud service or a folder in which data is stored, by using the operation unit 23 of the image processing apparatus 20. The controller 21 of the image processing apparatus 20 selects a cloud service or a folder in which data is stored, in accordance with information output from the operation unit 23. Further, the user U selects a combination of flows that are to be performed on the image data (flow combination) by using the operation unit 23. The controller 21 selects any one of plural flow combinations in accordance with information output from the operation unit 23 (step S1) and displays a list of flows included in the selected flow combination on the display 24.

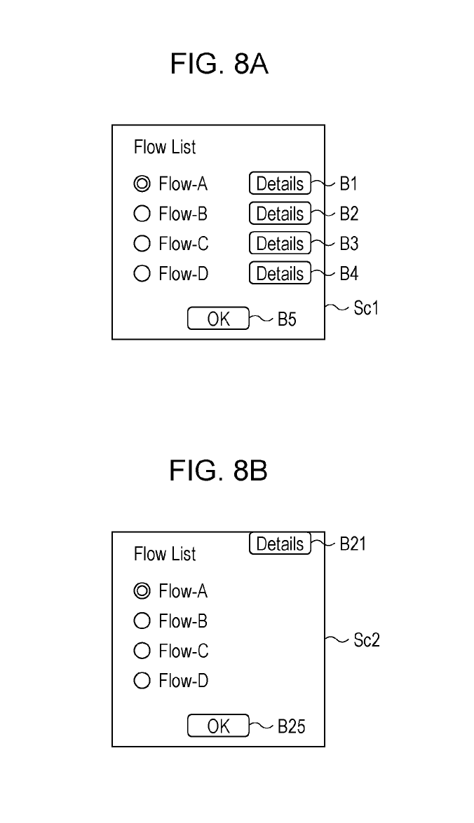

FIG. 8A is a diagram illustrating a screen of a list of flows displayed on the display 24. FIG. 8A illustrates an example of a screen in a case where a flow combination including “Flow-A”, “Flow-B”, “Flow-C”, and “Flow-D”, is selected. In the screen Sc1 illustrated in FIG. 8A, “Details” buttons B1, B2, B3, and B4, which are used for displaying detailed information on the respective flows, are displayed next to the names of the respective flows. Also, an “OK” button B5 for confirming the selection of a flow in the list (for providing an instruction to perform a flow) is displayed on the screen Sc1.

The user U checks the details of the individual flows by using the “Details” buttons B1, B2, B3, and B4 displayed on the screen Sc1. Upon any one of the “Details” buttons B1, B2, B3, and B4 being pressed by the user U, an image including the detailed content of the corresponding flow (the overview of the flow) and a form on which an attribute of the flow (processing condition) is to be written is printed by the image processing apparatus 20 (step S2 to step S7 in FIG. 7). Specifically, upon any one of the “Details” buttons B1, B2, B3, and B4 being pressed by the user U, the controller 21 transmits an apparatus ID identifying the own apparatus, information identifying the flow combination (hereinafter referred to as “flow combination information”), the name of the flow (processing identification data), and information representing a request for detailed information (hereinafter referred to as a “detailed information request”) to the relay apparatus 30 (step S2 in FIG. 7).

Upon receiving the apparatus ID, the flow combination information, the name of the flow, and the detailed information request from the image processing apparatus 20, the relay apparatus 30 transmits a request indicating the name of the flow and a request for detailed information regarding the flow to the flow management apparatus 40 (step S3).

Upon receiving the request from the relay apparatus 30, the controller 41 of the flow management apparatus 40 generates form data (page description language (PDL) data or the like) indicating that a character string identifying flow data and a form is to be described at a specific position, in accordance with the received request (step S4). FIG. 9A is a diagram illustrating an example of the content of form data that is generated. A character string included in the form data may be a character string that is randomly generated, or may be a character string generated by combining specific words. Also, the character string may be the same among plural flows, or may vary among plural flows. The character string may be located at a position that does not overlap the other characters or the like, for example, at a corner of the sheet.

The form data generated in step S4 includes data representing the items “explanation of flow”, “plug-in”, and “attribute”. The item “explanation of flow” includes data representing the overview and explanation of the flow. The item “plug-in” includes data representing a plug-in used in the flow. The item “attribute” includes data representing an image of a form that allows the user to select a processing condition (hereinafter referred to as an “attribute”) of the flow, such as resolution and color. The flow management apparatus 40 transmits the generated form data to the relay apparatus 30 (step S5). The relay apparatus 30 transfers the form data received from the flow management apparatus 40 to the image processing apparatus 20 (step S6). Upon receiving the form data from the relay apparatus 30, the image processing apparatus 20 supplies the received form data to the image forming unit 25 and causes the image forming unit 25 to form an image on a sheet (step S7).

FIG. 9A is a diagram illustrating an example of an image that is formed on a sheet in step S7. As illustrated in FIG. 9A, an image corresponding to data representing the individual items “explanation of flow”, “plug-in”, and attribute” is formed on a form sheet P1. In the example illustrated in FIG. 9A, an image including characters or a figure representing “explanation of Flow-A” is formed, an image including characters or a figure representing the content of plug-in is formed, and also an image of fields that are provided for individual attributes so that the user U writes the attributes of the flow therein is formed.

The user U checks the form sheet P1 on which an image has been formed by the image processing apparatus 20. The user U visually checks the “explanation of flow” and “plug-in” printed on the form sheet P1, thereby grasping the details of the flow and plug-in. In a case where the user U wants to change an attribute of the flow, the user U fills out the form on the form sheet. Specifically, for example, the user U writes a value “600 (dpi)”, “200 (dpi)”, or “500 (dpi)” for the item “resolution”, and writes a character string “monochrome” or “full-color” for the item “color”.

After writing the attributes, the user U performs an operation for causing the image processing apparatus 20 to read the filled-out form sheet and a sheet to be scanned, by using the operation unit 23. At this time, the user U may cause scan processing to be performed by superposing the form sheet on the sheet to be scanned. The controller 21 of the image processing apparatus 20 causes the image reading unit 26 to read an image in accordance with information output from the operation unit 23 (step S8). Accordingly, the image reading unit 26 reads the image on the sheet to be scanned and generates image data. The controller 21 transmits the generated image data and the flow combination information indicating the flow combination selected in step S1 to the relay apparatus 30 (step S9). The relay apparatus 30 transfers the image data and the flow combination information received from the image processing apparatus 20 to the flow management apparatus 40 (step S10).

Upon receiving the image data and the flow combination information from the relay apparatus 30, the controller 41 of the flow management apparatus 40 performs OCR processing on the received image data, and determines, in units of pages, whether or not a character string representing a form has been extracted from the image data. If a character string representing a form is extracted from the image data, the controller 41 determines that the image data is form data. Otherwise, the controller 41 determines that the image data is image data of the sheet to be scanned (step S11). In the process of comparing character strings, there is a probability that the character strings do not match each other due to misrecognition. In consideration of this, if there are plural pieces of image data from which a character string has been extracted, the controller 41 may determine image data including a character string of a high degree of similarity to be form data. In this case, the degree of similarity may be calculated on the basis of the number of characters or the number of the same characters included.

The controller 41 analyzes the form data, extracts attribute information written by the user U from the form data (step S12), and performs a flow (character recognition processing) on the image data in accordance with the attribute represented by the extracted attribute information (step S13). After the flow (character recognition processing) has finished, the controller 41 requests the processing service providing apparatus 50a to perform a flow (data format conversion processing) on the data generated by performing character recognition processing in accordance with the attribute represented by the extracted attribute information (step S14). The processing service providing apparatus 50a performs the flow (data format conversion processing) on the received data in response to the request from the flow management apparatus 40 (step S16), and transmits the data generated by performing the flow to the flow management apparatus 40 (step S18). The data on which the data format conversion processing has been performed by the processing service providing apparatus 50a is transmitted by the flow management apparatus 40 to the processing service providing apparatus 50b (step S15). The processing service providing apparatus 50b performs translation processing in accordance with the content of the request from the flow management apparatus 40 (step S17), and transmits the data on which translation processing has been performed to the flow management apparatus 40 (step S19).

After the flows represented by the flow combination information have finished, the flow management apparatus 40 transmits the data on which the flows have been performed to the relay apparatus 30 (step S20). The relay apparatus 30 transmits the data received from the flow management apparatus 40 to the storage service providing apparatus 10 designated by the user U (step S21), and the storage service providing apparatus 10 stores the data received from the relay apparatus 30 in a designated folder (step S22). The data is stored in the manner described above. According to this exemplary embodiment, even in a case where the display area of a user interface (UI) of an apparatus is small, for example, a user is capable of easily checking the overview of a flow and changing the attribute of the flow.

### Exemplary Modifications

The above-described exemplary embodiment is an example of the embodiment of the present invention, and may be modified in the following manner. Further, the following exemplary modifications may be implemented in combination with one another.

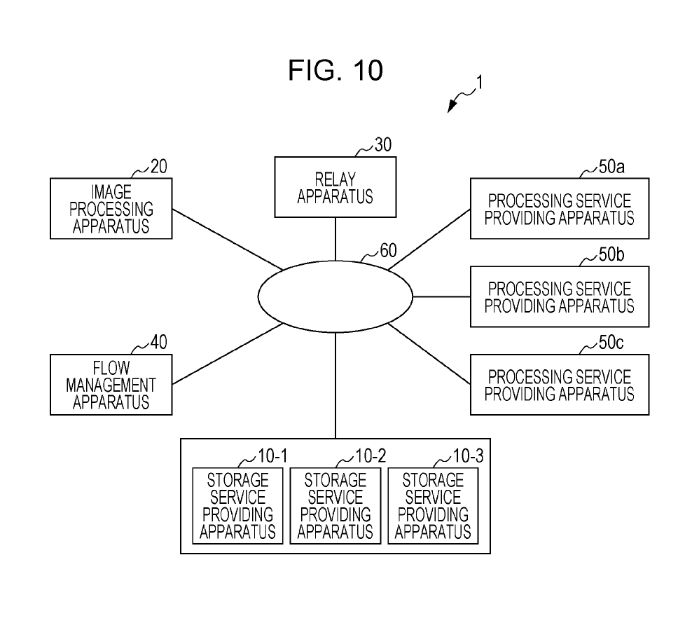

(1) The configuration of the communication system 1 is not limited to the configuration described above in the exemplary embodiment. For example, the number of individual apparatuses constituting the communication system 1 may be different from the number according to the exemplary embodiment. For example, in the above-described exemplary embodiment, the communication system 1 includes a single image processing apparatus 20. However, the number of image processing apparatuses 20 is not limited to one, and plural image processing apparatuses 20 may be provided. Further, in the above-described exemplary embodiment, a single storage service is provided by a single storage service providing apparatus, but a single storage service may be provided by plural server apparatuses. Specifically, for example, as illustrated in FIG. 10, a single storage service may be provided by plural storage service providing apparatuses 10-1, 10-2, and 10-3. Alternatively, a single processing service may be provided by plural processing service providing apparatuses.

In the above-described exemplary embodiment, a description has been given of a case where a single storage service is provided. The number of storage services is not limited to one, and may be two or more.

(2) The image processing apparatus 20 according to the above-described exemplary embodiment is an example of an apparatus that receives a service from the storage service providing apparatus 10 or the processing service providing apparatus 50 and that outputs image data. The image processing apparatus 20 may be another type of apparatus, such as a portable game machine.

(3) In the above-described exemplary embodiment, the relay apparatus 30 and the flow management apparatus 40 are constituted as separate apparatuses, but the relay apparatus 30 and the flow management apparatus 40 may be integrated together. The relay apparatus 30 and the flow management apparatus 40 are examples of an information processing apparatus according to an exemplary embodiment of the present invention.

(4) In the above-described exemplary embodiment, the controller 41 of the flow management apparatus 40 performs OCR processing on image data received from the relay apparatus 30, determines whether or not a character string representing a form has been extracted from the image data, and thereby determines whether or not the image data is form data. A method for determining whether or not the image data is form data is not limited to this method, and another method may be used. For example, determination may be performed by using a predetermined figure or QR code instead of a character string.

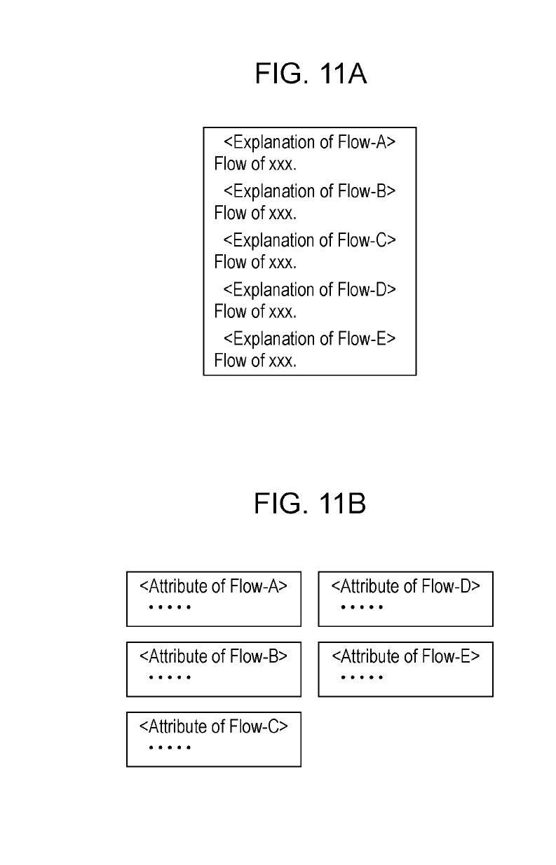

(5) In the above-described exemplary embodiment, the screen Sc1 illustrated in FIG. 8A is given as an example of a screen displayed on the display 24 of the image processing apparatus 20. The screen showing a flow list is not limited thereto, and another screen may be used. For example, as illustrated in FIG. 8B, a screen Sc2 may be displayed in which a single “Details” button B21 is provided for all the flows. In this case, upon pressing of the “Details” button B21, the explanations and forms of all the flows may be formed on the same sheet in units of flows, as illustrated in FIG. 11A. Alternatively, as illustrated in FIG. 11B, form sheets for the individual flows may be output. The user checks the form sheet or form sheets on which the explanations and forms of the flows are printed, selects a flow, writes an attribute on the form data corresponding to the selected flow, and causes the image processing apparatus 20 to scan the form data.

(6) In the above-described exemplary embodiment, the image illustrated in FIG. 9A is given as an example of an image which the image processing apparatus 20 forms on a form sheet. The image formed on a form sheet is not limited thereto, and may be another image. For example, the image illustrated in FIG. 9B or 9C may be used. Any image may be used as long as the image includes an overview (explanation) of the flow and an image that allows a user to write an attribute of the flow. In the example illustrated in FIG. 9B, check boxes that are used for selecting any one of “high”, “middle”, and “low” as “resolution” are printed, and also check boxes that are used for selecting any one of “monochrome” and “full-color” as “color” are printed. In the example illustrated in FIG. 9C, check boxes that are used for selecting any one of “600 dpi”, “200 dpi”, and “50 dpi” as “resolution” are printed on a form sheet.

(7) In the above-described exemplary embodiment, data including form data representing a form that is used by a user to write a processing condition of a flow and overview data representing the overview of the flow is used as flow data representing information related to an information processing operation (flow). However, the configuration of the flow data is not limited to the configuration including both form data and overview data. For example, the flow data may not include overview data, or the flow data may not include form data.

In the above-described exemplary embodiment, the user writes a processing condition of a flow on a form sheet, and the controller 41 of the flow management apparatus 40 specifies the processing condition of the flow on the basis of filled-out form data. However, the user does not necessarily write a processing condition of the flow on the form sheet (that is, the controller 41 does not specify a processing condition of the flow). For example, in a case where flow data includes only overview data (that is, flow data does not include form data), the image forming unit 25 forms an image representing the overview of the flow on a sheet, and does not form an image representing a form on the sheet. In this case, the user checks the image representing the overview of the flow formed on the sheet, and thereby grasps the details of the flow.

(8) The program executed by the image processing apparatus 20, the relay apparatus 30, and the flow management apparatus 40 may be downloaded via a communication line such as the Internet. Alternatively, the program may be provided by being recorded on a computer readable recording medium, such as a magnetic recording medium (a magnetic tape, a magnetic disk, or the like), an optical recording medium (an optical disc or the like), a magneto-optical recording medium, or a semiconductor memory.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication system comprising:
an information processing apparatus; and
an image processing apparatus,
the information processing apparatus including
an image data receiving unit that receives image data from the image processing apparatus,
a memory that stores, for each of a plurality of information processing operations that are performed by using the image data received by the image data receiving unit, processing identification data identifying the information processing operation and processing-related data representing information on the information processing operation in association with each other,
a processing identification data receiving unit that receives, from the image processing apparatus, processing identification data identifying an information processing operation selected by a user,
a processing-related data transmitting unit that transmits, to the image processing apparatus, the processing-related data stored in the memory in association with the processing identification data received by the processing identification data receiving unit, and
a processing unit that performs, by using the image data received by the image data receiving unit, processing related to the information processing operation identified by the processing identification data received by the processing identification data receiving unit, and
the image processing apparatus including
an image data obtaining unit that obtains image data,
an image data transmitting unit that transmits the image data obtained by the image data obtaining unit to the information processing apparatus,
a processing identification data transmitting unit that transmits, to the information processing apparatus, processing identification data identifying an information processing operation selected by the user from among a plurality of information processing operations that are performed by using the image data obtained by the image data obtaining unit,
a processing-related data receiving unit that receives processing-related data representing information on the information processing operation, the processing-related data being transmitted from the information processing apparatus as a response to the processing identification data transmitted by the processing identification data transmitting unit, and
an image formation instruction unit that instructs an image forming device that forms an image on a recording medium to form an image representing information represented by the processing-related data received by the processing-related data receiving unit.

2. The communication system according to claim 1, wherein
the processing-related data is data representing a form on which a condition of an information processing operation is to be written by the user,
the image data receiving unit receives, from the image processing apparatus, image data including filled-out form data representing an image of a form that has been filled out by the user,
the information processing apparatus further includes a specifying unit that specifies a condition of an information processing operation, the condition being written by the user and included in the form represented by the filled-out form data received by the image data receiving unit,
the processing unit performs the processing by using the image data received by the image data receiving unit so that the information processing operation identified by the processing identification data received by the processing identification data receiving unit is performed in the condition specified by the specifying unit,
the image formation instruction unit instructs the image forming device to form an image of a form represented by the processing-related data received by the processing-related data receiving unit, and
the image data obtaining unit obtains image data including filled-out form data representing an image of a form that has been filled out by the user, the image of the form being formed by the image forming device and recorded on a recording medium.

3. The communication system according to claim 1, wherein the processing-related data includes data representing an overview of the information processing operation.

4. The communication system according to claim 2, wherein the processing-related data includes data representing an overview of the information processing operation.

5. An information processing apparatus comprising:
an image data receiving unit that receives image data from an image processing apparatus;
a memory that stores, for each of a plurality of information processing operations that are performed by using the image data received by the image data receiving unit, processing identification data identifying the information processing operation and processing-related data representing information on the information processing operation in association with each other;
a processing identification data receiving unit that receives, from the image processing apparatus, processing identification data identifying an information processing operation selected by a user;
a processing-related data transmitting unit that transmits, to the image processing apparatus, the processing-related data stored in the memory in association with the processing identification data received by the processing identification data receiving unit, the image processing apparatus instructing an image forming device that forms an image on a recording medium to form an image representing information represented by the processing-related data; and
a processing unit that performs, by using the image data received by the image data receiving unit, processing related to the information processing operation identified by the processing identification data received by the processing identification data receiving unit.

6. An image processing apparatus comprising:
an image data obtaining unit that obtains image data;
an image data transmitting unit that transmits the image data obtained by the image data obtaining unit to an information processing apparatus;
a processing identification data transmitting unit that transmits, to the information processing apparatus, processing identification data identifying an information processing operation selected by a user from among a plurality of information processing operations that are performed by using the image data obtained by the image data obtaining unit;
a processing-related data receiving unit that receives processing-related data representing information on the information processing operation, the processing-related data being transmitted from the information processing apparatus as a response to the processing identification data transmitted by the processing identification data transmitting unit; and
an image formation instruction unit that instructs an image forming device that forms an image on a recording medium to form an image representing information represented by the processing-related data received by the processing-related data receiving unit.

7. A non-transitory computer readable medium storing a program causing a computer to execute a process, the process comprising:
receiving image data from an image processing apparatus;
storing, for each of a plurality of information processing operations that are performed by using the received image data, processing identification data identifying the information processing operation and processing-related data representing information on the information processing operation in association with each other;
receiving, from the image processing apparatus, processing identification data identifying an information processing operation selected by a user;
transmitting, to the image processing apparatus, the processing-related data stored in association with the received processing identification data, the image processing apparatus instructing an image forming device that forms an image on a recording medium to form an image representing information represented by the processing-related data; and
performing, by using the received image data, processing related to the information processing operation identified by the received processing identification data.

8. A non-transitory computer readable medium storing a program causing a computer to execute a process, the process comprising:
obtaining image data;
transmitting the obtained image data to an information processing apparatus;
transmitting, to the information processing apparatus, processing identification data identifying an information processing operation selected by a user from among a plurality of information processing operations that are performed by using the obtained image data;
receiving processing-related data representing information on the information processing operation, the processing-related data being transmitted from the information processing apparatus as a response to the transmitted processing identification data; and
instructing an image forming device that forms an image on a recording medium to form an image representing information represented by the received processing-related data.
